(19) United States
(12) Patent Application Publication
(10) Pub. No.: US 2010/0310061 A1
(43) Pub. Date: Dec. 9, 2010

(54) Account number security system with communication system

(75) Inventors: Andy Lin, Taipei (TW); Ayasuke Jiang, Taipei (TW)

Correspondence Address: Muncy, Geissler, Olds & Lowe, PLLC, 4000 Legato Road, Suite 310, FAIRFAX, VA, 22033, US

(73) Assignee: Game Flier International Corporation

(21) Appl. No.: 11/826,041

(22) Filed: Jul. 11, 2007

(30) Foreign Application Priority Data
Mar. 20, 2007 (TW) 096109603

(51) Int. Cl. H04M 15/06

(52) U.S. Cl. 379/142.05

(57) ABSTRACT

An account number security system with communication system, which, prior to and after a user uses a specific account number, includes the following steps: (a) dialing up a host server using a communication equipment provided with a specific number; (b) receiving of the incoming call and retrieving the telephone number by the host server; (c) storing of the incoming telephone number in a data bank by the host server; (d) comparing of the incoming telephone number with contents of already registered account number data for matching data; (e) enabling or locking of the account number of the user when matching data is found; and (f) terminating comparing of data when no matching data is found. According to the above steps, the present invention improves upon prior art in which unrecoverable loss to users occurs due to account numbers and passwords being easily leaked or misappropriated.

### BACKGROUND OF THE INVENTION

(a) Field of the Invention

The present invention relates to an account number security system with communication system, and more particularly to operating procedures that require a communication equipment provided with a specific number to be used to dial a telephone number and authenticate and enable or lock individual account numbers.

(b) Description of the Prior Art

Following the continuous development of modern science and technology, people are now able to manage many large and small matters in life through the use of a computer and the Internet. Regardless of whether its food, clothing, accommodation, travel, education or entertainment, to the largest government agencies and businesses, or to the smallest household and individual, the use of a computer is required to accomplish a large number of matters. For example, in order to be able to rapidly propagate news, regardless of whether it s a company store or the individual, use of their own specialized website and establishing their own blog (web log) are already extremely widespread. Another usage mode is electronic mail, which is a method to transmit individual news through a network to other specific persons or specific groups, mass use of which has been made of in the daily lives of people following the popularization of the computer and network systems.

In addition to the aforesaid, the use of a network system is also becoming increasingly more common, and because promotion and sale of commodities through presentation on a network is more economical compared to traditional advertising in newspapers, broadcasting, advertising on automobiles, and so on, and because of a search feature provided by a network, thus, the network provides even greater benefit to advertising, and is able to more rapidly contact the required customer or locate the required supplier or manufacturer. Moreover, network gaming is a new application with an emerging group of customers, wherein, after registering with the game provider, the user is able to interact with different users, and at the same time, the game provider also provides some virtual devices for use by the users during the course of the game. However, such virtual devices usually require payment for use thereof, thereby providing the game provider with its primary source of income. The user invests a great deal of expense and energy in participating in the game platform and accumulating his own experience to obtain even more practical virtual devices. Moreover, the virtual devices obtained are usually able to be resold to other people at corresponding market prices through the network, bringing profit to the users.

However, following the continuous rise in the number of users, profit contained within the aforementioned application mode correspondingly increases, and certain users having relatively greater wealth or virtual devices become the object of coveting by unworthy personage. Such unworthy personage use different techniques, including stealthily acquiring of data, implanting Trojan horse programs, directly invading the computer, and so on, in order to obtain account number data of such users and information on individuals, and, after acquiring such, the virtual devices are then sold off, or credit card account numbers of users are misappropriated, even making use of the account numbers of users to engaged in illegal acts, thereby causing great anguish to the embezzled users.

In actual use, conventionally, the user needs only to input his account number name and password into the security system when he wants to use his account number, and although such a method is relatively convenient, however, it actually presents a large security loophole, with the result that often causes injury to the interest of the users themselves when account number data of users is leaked out or misappropriation occurs, which is a contributory factor affecting the inclination of the users to use such a system. Furthermore, such a situation results in the customer group of the suppliers providing the account number service gradually disappearing. Hence, the platform that was originally designed to provide everybody with the ability to interact with each other has come under the influence of misgivings over security, which has caused the suppliers providing the account number service and the users to sustain loss. Such a situation is not what is hoped for.

### SUMMARY OF THE INVENTION

Accordingly, a primarily objective of the present invention is to provide an account number security system with communication system that improves upon security shortcomings of prior art resulting from the user inputting his account number and password through a network to alter the account number condition.

In order to achieve the aforementioned objective, the present invention provides a security system, which, prior to and after a user uses a specific account number, comprises the following steps:

(a) dialing up a host server using a communication equipment provided with a specific number;

(b) receiving of the incoming call and retrieving the telephone number by the host server;

(c) storing of the incoming telephone number in a data bank by the host server;

(d) comparing of the incoming telephone number with contents of already registered account number data for matching data;

(e) enabling or locking of the account number of the user when matching data is found; and

(f) terminating comparing of data when no matching data is found. According to the above steps, the security system with communication system of the present invention improves upon prior art in which unrecoverable loss to users occurs due to account numbers and passwords being easily leaked or misappropriated.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows a schematic flowchart of the steps involved in a preferred embodiment according to the present invention.

FIG. 2 shows a schematic view of the present invention in actual use.

FIG. 3 shows a schematic flowchart of the steps involved in a feasible embodiment according to the present invention.

### DETAILED DESCRIPTION OF THE PREFERRED EMBODIMENTS

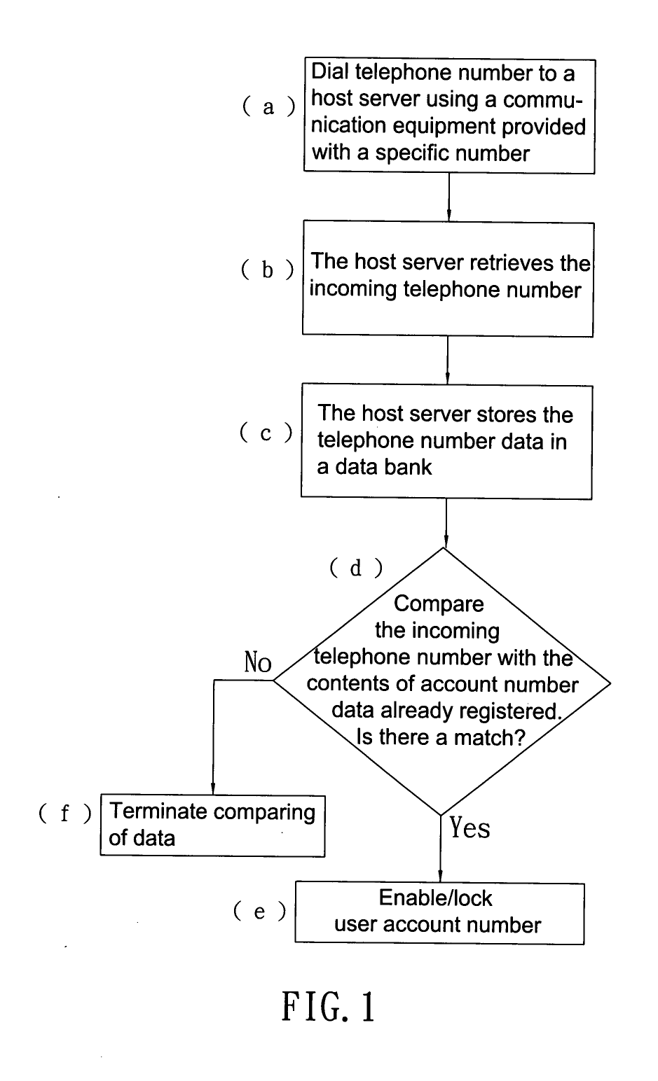

Referring to FIG. 1, which shows the basic framework of a security system of the present invention, which, prior to and after a user uses a specific account number, comprises the following steps:

(a) dialing up a host server using a communication equipment provided with a specific number;

(b) receiving of the incoming call and retrieving the telephone number by the host server;

(c) storing of the incoming telephone number in a data bank by the host server;

(d) comparing of the incoming telephone number with contents of already registered account number data for matching data;

(e) enabling or locking of the account number of the user when matching data is found; and

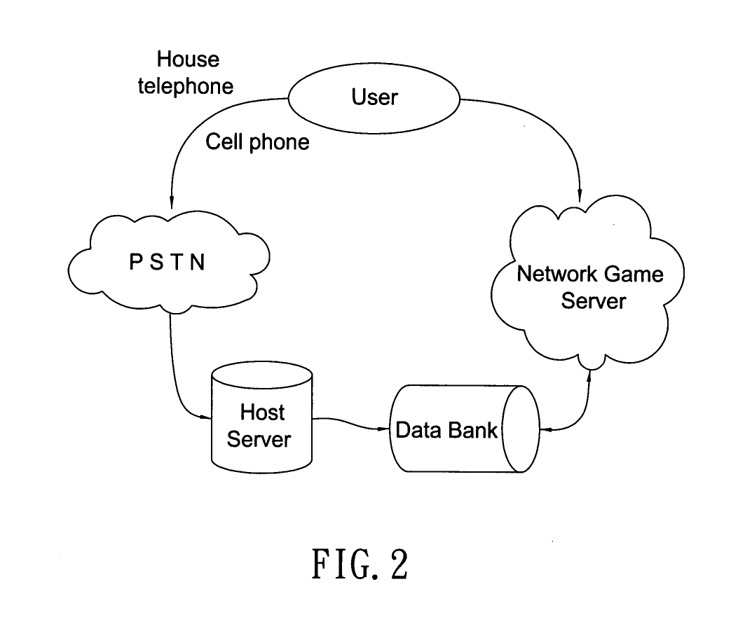

(f) terminating comparing of data when no matching data is found. Referring to FIG. 2, which shows a connection relationship between a network game platform provided by a network game provider and a user, wherein the communication equipment used by the user in step (a) is equipment able to dial a fixed telephone number, such as a general house telephone or a mobile phone, which are communication equipment the user has in their own possession, and have the distinction of being difficult to duplicate or steal. When the user uses such a communication equipment to dial a specific telephone number (for example: 0800-123-456), a connection is formed with the host server provided with a telephone answering function through the public network (PSTN, public switched telephone network). In step (b), the host server receives the incoming call through the public network. In the embodiment of the present invention, the host server is set up to be able to read the configuration of the telephone number of the incoming call from the user, and immediately disconnects the incoming call after retrieving the telephone number. For example: the host server disconnects the incoming call after the user hears five rings, then step (c) is implemented. In step (c), the telephone number data is read into the data bank connected to the host server. In the embodiment of the present invention, the data bank is a host computer provided with operational capability. In step (d), the data bank compares the obtained telephone number data with user data stored in the data bank, and searches for an existing registered user that matches the telephone number data.

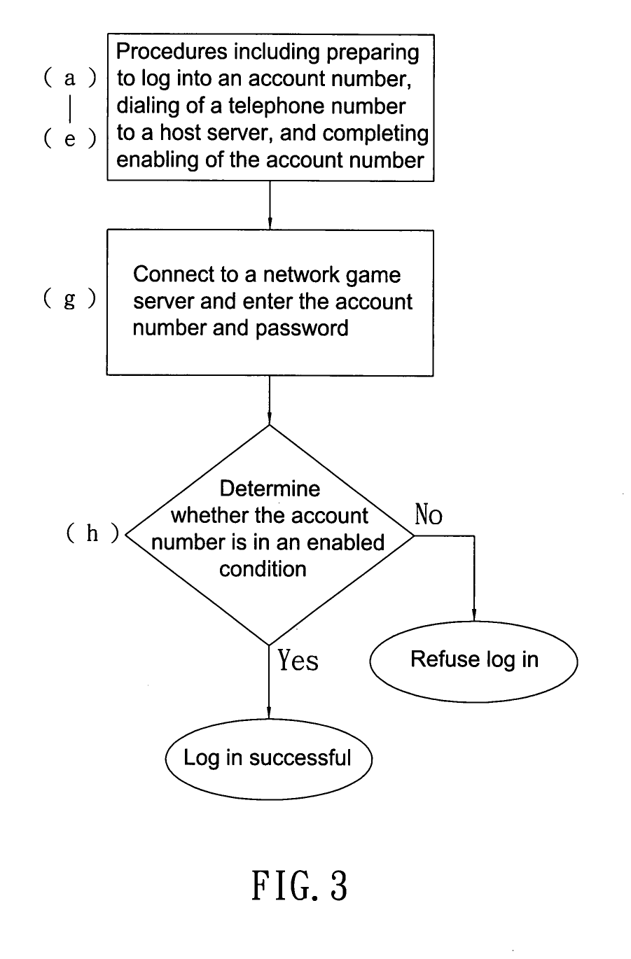

In the embodiment adopted in the present invention, when the result of comparing data in step (d) successfully locates the corresponding user data, then the data bank executes step (e), and the account number of the user is altered from the original not-enabled (locked) condition to an enabled condition. Referring to FIG. 3, after the account number of the user is set to the enabled condition, then the user carries out step (g), whereby the user enters the network game server set up by the network game provider through a personal computing equipment and inputs his account number and password. An embodiment adopted by the network game server enables forming an on-line mode with the data bank, which is used to read the account number condition of all users stored within the data bank, thereby enabling renewing the condition of the user account originally stored on the network game server. In a feasible disposition, the network game server connects to the data bank and implements the renewal operation of the account number condition at fixed times. After the user has carried out the procedure to dial the telephone number and enable the account number, then the account number is set to the enabled condition, and after renewing the connection between the network game server and the data bank, then the user carries out the procedure of step (g) and inputs his account number password, thereby enabling the user to use his own account number to enter the network game server.

In the embodiment adopted in the present invention, when preparing to use his specific account number, the user first carries out the procedure of step (a) and dials the telephone number to connect to the host server or connects to the host server through a telephone switchboard, whereupon, the host server sequentially executes steps (b) and (c), and the data bank executes steps (d) and (e) to compare data and enable the account number. Moreover, the personal computer (or a portable device provided with the function to access a network, such as an intelligent cell phone) of the user forms, in essence, a connection relationship with the network game server. Furthermore, after completing the procedure of step (g), whereby the user inputs his account number and password to the network game server, the adopted embodiment further comprises a step (h), wherein the network game server determines whether or not the account number of the user is in the enabled condition. If the account number of the user is in the enabled condition, then the account number is allowed to log into the network game server; otherwise, the network game server rejects the account number and disables the user from logging into the game.

Referring to FIGS. 1 and 3, after the user has finished using his account number, then step (a) provides for dialing another specific telephone number (for example: 0800-456-789) provided by the supplier, and after retrieving and comparing of data executed in the procedures of steps (b) to (d), then step (e) again alters and sets the account number to the locked condition. After the aforementioned procedures for locking the account number are executed, even if some person misappropriates the account number and password of a user, and completes the procedure of step (g) by inputting the account number and password, nevertheless, because the account number is in the locked condition, and the embezzler does not have the unique communication equipment of the user to implement enabling the account procedure of step (a), thus the checking operation procedure of step (h) will refuse logging into the network game server, thereby safeguarding the rights and interests of the user.

The aforementioned demonstrates that, compared to a network account of prior art which only includes an enabling step of inputting an account number and password, the account number security system with a communication system of the present invention provides the user with a superior double protection system, comprising operating procedures including using a cell phone or a house telephone to enable an account number, which thwarts a common computer hacker from being able to crack the system or to stealthily acquire account number data in order to steal user information, and assuredly increases the security and reliability of the account numbers of users. Furthermore, when a time arises for temporary need to use an account number, but the user cannot find a computer or it is not convenient to use the computer, then the user may entrust a family member or good friend, and after the user dials his personal specific telephone (that which has user information recorded in the data bank) and completes the operating procedures required to enable the account number, then the exclusive account number of the user is allowed connection to the server and operations can be carried out, thereby providing flexibility in use of the account number while the system necessitates confirmation of the individual user and enabling of the account number, which increases and guarantees security of user account data.

In conclusion, the account number security system with communication system of the present invention provides the network service supplier or website with a registration service unit that increases data security for existing account number services by means of the enabling or locking procedure of the physical communication equipment of the user, thereby improving upon the possible risks of misappropriation brought about by enabling of account numbers merely through the network of prior art. Furthermore, the host server only needs to obtain the incoming telephone number of the user, and does not need to implement communication with the user, thereby simplifying the operating procedure and obviating the need for expenditure on connection costs. The present invention provides the user with a more convenient and economical security system, and assuredly increases the security of account numbers of users. Moreover, the present invention relieves anxiety over security of account numbers, thereby bringing reassurance in use of the security system. The present invention has demonstrated the industrial practicability and advancement of the security system, and clearly complies with essential elements as required for a new patent application.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An account number security system with communication system, wherein, prior to and after a user uses a specific account number, comprises the following steps:
(a) dialing up a host server using a communication equipment provided with a specific number;
(b) receiving of the incoming call and retrieving the telephone number by the host server;
(c) storing of the incoming telephone number in a data bank by the host server;
(d) comparing of the incoming telephone number with contents of already registered account number data for matching data;
(e) enabling or locking of the account number of the user when matching data is found; and
(f) terminating comparing of data when no matching data is found.

2. The account number security system with communication system according to claim 1, wherein after the user dials the telephone number of step (a), the call is connected to the host server through a telephone switchboard; accordingly, such a telephone call connects to a telephone switchboard, whereafter the telephone switchboard transfers the call to the host server.

3. The account number security system with communication system according to claim 1, wherein a step (f), terminating comparing of data, is provided when there is no matching user data found after comparing of the telephone number data with all user data of step (d).

4. The account number security system with communication system according to claim 1, wherein a step (g) is provided after step (e), in which the user enters a network server set up by a network provider through a personal computing equipment and inputs his account number and password.

5. The account number security system with communication system according to claim 4, wherein a step (h) is provided after step (g), in which the network server determines whether or not the account number of the user is in an enabled condition.

6. The account number security system with communication system according to claim 4, wherein the personal computing equipment is a portable device provided with the function to access a network.

7. The account number security system with communication system according to claim 5, wherein the personal computing equipment is a portable device provided with the function to access a network.

8. The account number security system with communication system according to claim 1, wherein the communication equipment is a cell phone or a house telephone.

9. The account number security system with communication system according to claim 3, wherein the communication equipment is a cell phone or a house telephone.

10. The account number security system with communication system according to claim 4, wherein the communication equipment is a cell phone or a house telephone.

11. The account number security system with communication system according to claim 5, wherein the communication equipment is a cell phone or a house telephone.

12. The account number security system with communication system according to claim 6, wherein the communication equipment is a cell phone or a house telephone.

13. The account number security system with communication system according to claim 7, wherein the communication equipment is a cell phone or a house telephone.
